(19) United States
(12) Patent Application Publication
(10) Pub. No.: US 2014/0232748 A1
(43) Pub. Date: Aug. 21, 2014

(54) DEVICE, METHOD AND COMPUTER READABLE RECORDING MEDIUM FOR OPERATING THE SAME

(71) Applicant: Samsung Electronics Co., Ltd., Suwon-si (KR)

(72) Inventors: Gennadiy Yaroslavovich KIS, Kyiv (UA); Oleksiy Seriovych PANFILOV, Kiev (UA); Kyu-Sung CHO, Suwon-si (KR); Fedor Ivanovych ZUBACH, Kyiv (UA); Ik-Hwan CHO, Suwon-si (KR)

(73) Assignee: Samsung Electronics Co., Ltd., Suwon-si (KR)

(21) Appl. No.: 14/181,119

(22) Filed: Feb. 14, 2014

Related U.S. Application Data
(60) Provisional application No. 61/765,422, filed on Feb. 15, 2013.

(30) Foreign Application Priority Data
Feb. 10, 2014 (KR) 10-2014-0014856

(51) Int. Cl. G06T 19/00; G06T 7/00

(52) U.S. Cl. CPC G06T 19/006; G06T 7/0042
USPC 345/633

(57) ABSTRACT

A method of operating an electronic device is provided. The method includes recognizing at least one object from a digital image, wherein the recognizing of the object includes generating at least one descriptor from the digital image, determining an object in the digital image on a basis of at least one part of the at least one descriptor and identification data corresponding to the at least one reference object, and determining a pose of the object on a basis of at least one part of the reference descriptor corresponding to the determined object and the at least one descriptor.

### CROSS-REFERENCE TO RELATED APPLICATION(S)

This application claims the benefit under 35 U.S.C. §119(e) of a U.S. Provisional application filed on Feb. 15, 2013 in the U.S. Patent and Trademark Office and assigned Ser. No. 61/765,422, and under 35 U.S.C. §119(a) of a Korean patent application filed on Feb. 10, 2014 in the Korean Intellectual Property Office and assigned Serial number 10-2014-0014856, the entire disclosure of each of which is hereby incorporated by reference.

### TECHNICAL FIELD

The present disclosure relates to a method for operating an electronic device.

### BACKGROUND

Typically, Virtual Reality (VR) refers to a lifelike environment or situation created by computer graphics, and includes an interface that allows people to perceive a virtual environment or situation through their sensory organs and believe that they are actually interacting with the virtual environment or situation. A user may interact with virtual reality environment in real time and have a sensory experience similar to that of reality through device control.

In addition, Augmented Reality (AR) is one field of virtual reality, and refers to a computer graphic technology that combines virtual objects or information with the real environment to make the virtual objects or information appear as if they exist in the original environment. AR is a technology for overlaying virtual objects on the real world as seen through the user's eyes, and is also referred to as Mixed Reality (MR) because it mixes the real world with additional information and a virtual world and shows the mixture as one image.

Further, as mobile devices (e.g., a smart phone, a tablet PC, etc.) are gaining popularity, the virtual reality technology may be frequently and easily found in various services such as education, games, navigation, advertisements, and blogs. As wearable devices are now commercially available, research on the virtual reality technology becomes more active.

Accordingly, a method and apparatus for recognizing at least one object of a digital image by generating a descriptor from the digital image, determining an object from within the digital image from information of the descriptor and identification data corresponding to a reference object and determining a pose of the object based upon a reference descriptor corresponding to the determined object and the descriptor is desired.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for recognizing at least one object of a digital image by generating a descriptor from the digital image, determining an object from within the digital image from information of the descriptor and identification data corresponding to a reference object and determining a pose of the object based upon a reference descriptor corresponding to the determined object and the descriptor.

In order to provide Augmented Reality (AR), features and descriptors may be calculated on image data, an object on the image data may be recognized using the calculated features and descriptors, and localization (initial pose calculation) of the recognized object may be performed.

However, a large amount of computation is required for the object recognition and the localization. Therefore, when the object recognition and the localization are performed in the electronic device, a processing speed may be reduced due to a limited size of a memory and accurate object recognition may be difficult. For example, it is important that the accurate object recognition is performed with a small size of the memory because there is a restriction of a memory in a mobile terminal such as a smart phone, or the like.

Therefore, when a query step performed in the object recognition process and a localization step, which calculates an initial pose of an object output as a result of the query step, are performed, various embodiments of the present disclosure load only data required in each step in the memory and calculate the data so that an accurate and quick object recognition is possible in an electronic device with a just small size of the memory, and a method and computer readable recording medium for operating the electronic device may be provided.

In accordance with an aspect of the present disclosure, a method of operating an electronic device is provided. The method includes recognizing at least one object from a digital image. The recognizing of the object comprises generating at least one descriptor from the digital image, determining an object in the digital image on a basis of at least one part of the at least one descriptor and identification data corresponding to the at least one reference object, and determining a pose of the object on a basis of at least one part of the reference descriptor corresponding to the determined object and the at least one descriptor.

Another aspect of the present disclosure is to provide a method of operating an electronic device. The method comprising recognizing an object from a digital image on a basis of object data stored in a database and descriptor data related to each object data. The recognizing of the object comprises determining an object in the image by using the object data, and determining a pose of the object on a basis of at least one part of one or more descriptors related to the determined object.

Another aspect of the present disclosure is to provide an electronic device. The electronic device includes a memory configured to store a digital image, and a processor configured to process the digital image. The processor includes a recognition unit configured to generate at least one descriptor from the digital image and determines an object in the digital image on a basis of at least one part of at least one reference object and identification data corresponding to the at least one descriptor, and a localization unit configured to determine a pose of the object on a basis of at least one part of the reference descriptors corresponding to the determined object and the at least one descriptor.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device according to an embodiment of the present disclosure.

FIG. 2 is a block diagram illustrating a structure of an Augmented Reality (AR) processing unit according to an embodiment of the present disclosure.

FIG. 3 is a block diagram illustrating a detailed structure of an AR processing unit according to an embodiment of the present disclosure.

FIG. 4 illustrates a system according to an embodiment of the present disclosure.

FIG. 5 is a flowchart illustrating a process of operating an electronic device according to an embodiment of the present disclosure;

FIG. 6 is a flowchart illustrating a procedure of operating an electronic device according to an embodiment of the present disclosure;

FIG. 7A illustrates a feature having a dark attribute according to an embodiment of the present disclosure;

FIG. 7B illustrates a feature having a bright attribute according to an embodiment of the present disclosure;

FIG. 8 illustrates data fields stored in a memory according to an embodiment of the present disclosure;

FIG. 9 illustrates a K-Dimensional (KD) tree structure according to an embodiment of the present disclosure;

FIG. 10 illustrates a KD tree structure in which a nearest neighbor is displayed according to an embodiment of the present disclosure;

FIG. 11 is a block diagram illustrating a detailed structure of an electronic device according to an embodiment of the present disclosure; and

FIG. 12 illustrates a software architecture of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dicates otherwise. Thus, for example, reference to “a component surface” includes reference to one or more of such surfaces.

Unless defined otherwise, all terms used herein, including technical terms and scientific terms, have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification.

In various embodiments of the present disclosure, a method of using multiple reference image recognition by a feature point sequential classification, or the like is initiated for implementation of Augmented Reality (AR).

In the following description of various embodiments of the present disclosure, an “electronic device” may be any device equipped with at least one processor, and may include a camera, a portable device, a mobile terminal, a communication terminal, a portable communication terminal, a portable mobile terminal, and the like. As an example, the electronic device may be a digital camera, a smart phone, a mobile phone, a gaming machine, a Television (TV), a display device, a head unit for a motor vehicle, a notebook computer, a laptop computer, a tablet computer, a Personal Media Player (PMP), a Personal Digital Assistant (PDA), a navigation device, an Automated Teller Machine (ATM) for banking, a POS device of a shop, or the like. Further, the electronic device in various embodiments of the present disclosure may be a flexible device or a flexible display unit. Further, the electronic device in various embodiments of the present disclosure may be a wearable device (e.g., watch type device, glass type device, suit type device, etc.).

Hereinafter, various embodiments of the present disclosure will be described in detail with reference to the accompanying drawings so that a person having ordinary skill in the art may easily embody the present disclosure.

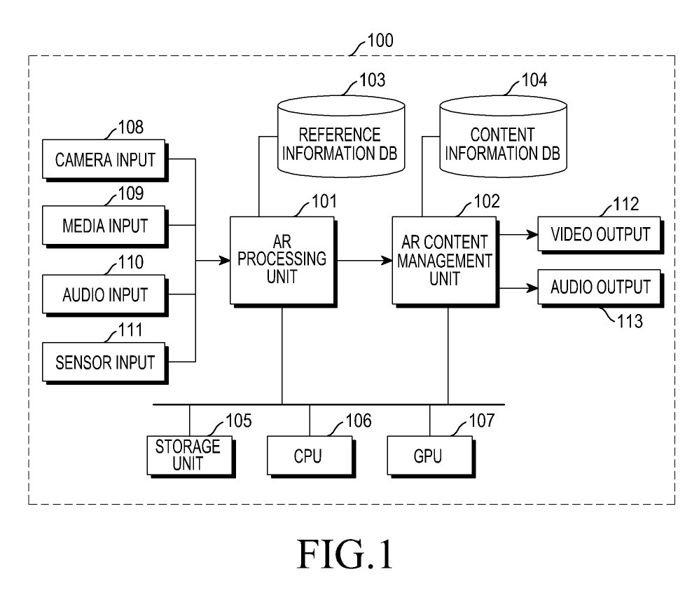

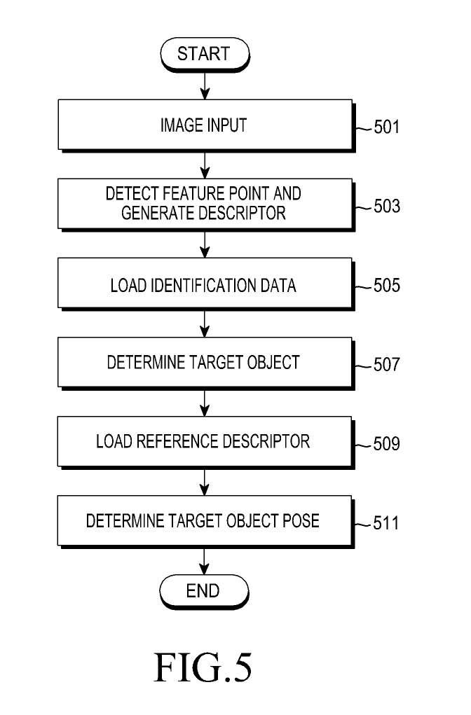

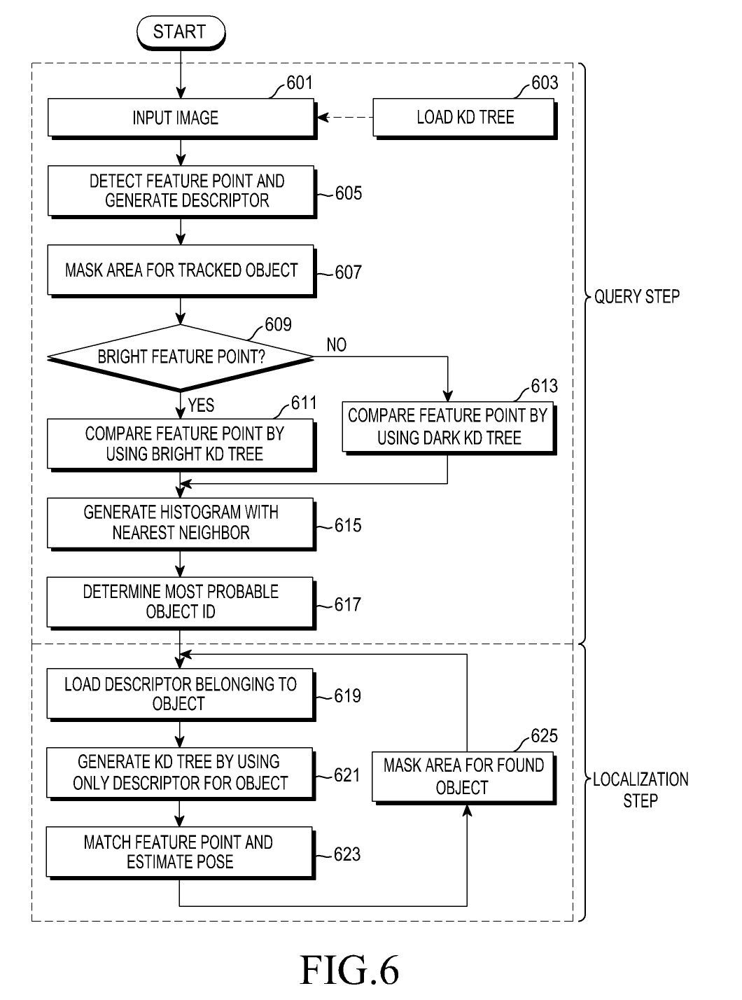

A structure of a system and apparatus according to an embodiment of the present disclosure will be first described with reference to FIGS. 1 to 4, and a procedure according to an embodiment of the present disclosure will be described in detail with reference to FIGS. 5 and 6.

FIG. 1 is a block diagram illustrating an electronic device according to an embodiment of the present disclosure.

Referring to FIG. 1, the electronic device 100 according to an embodiment of the present disclosure may include an AR processing unit 101 and an AR content management unit 102. Also, the electronic device 100 according to an embodiment of the present disclosure may further include a reference information Database (DB) 103, a content information DB 104, a storage unit 105, a CPU 106, a Graphical Processing Unit (GPU) 107, and the like.

The AR processing unit 101 may receive data input from several input units such as a camera input module 108, a media input module 109, an audio input module 110, and a multi-sensor input module 111. The sensor input data may include input data from an accelerometer, a gyroscope, a magnetic sensor, a temperature sensor, a gravity sensor, and the like.

The AR processing unit 101 may use the storage unit 105, the CPU 106, and the GPU 107 for essential processing of input data. The AR processing unit 101 may use the reference information DB 103 to identify and recognize target objects. An output from the AR processing unit 101 may include, for example, identification information and localization information.

The localization information may be used to determine a 2D/3D pose of a target object. The identification information may be used to determine what the target object is. The AR content management unit 102 may be used to organize a final video output 112 and audio output 113 with an output from the AR processing unit 101 and contents from the remote/local content information DB 104.

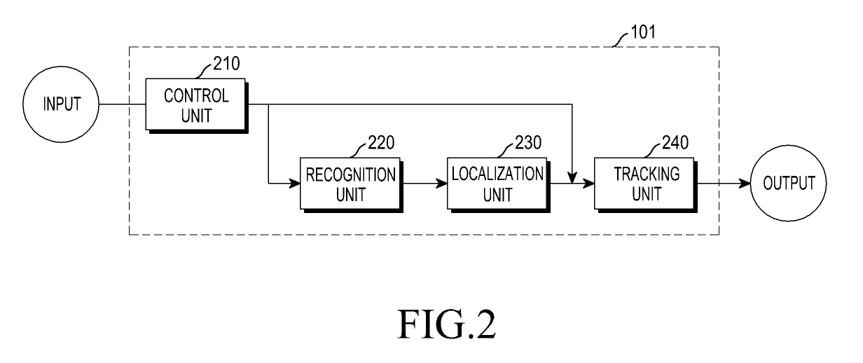

FIG. 2 illustrates a configuration of the AR processing unit 101, shown in FIG. 1, according to an embodiment of the present disclosure.

Referring to FIG. 2, the AR processing unit 101 according to an embodiment of the present disclosure may include at least one of a control unit 210, a recognition unit 220, a localization unit 230, and a tracking unit 240.

The control unit 210 may determine whether to branch into recognition processing through the recognition unit 220 or proceed to tracking processing through the tracking unit 240. While the recognition processing through the recognition unit 220 may be performed in parallel with the tracking processing through the tracking unit 240, the control unit 210 makes the best determination to perform optimized processing by using a given input. As an example, main processing through the AR processing unit 101 may include three steps of “recognition”, “localization”, and “tracking”.

The recognition unit 220 may identify a target object, based at least partially on reference information provided through the local/remote reference information DB 104, if necessary.

In some various embodiments of the present disclosure, the recognition unit 220 may need reference information for a specific recognized target object. The reference information may be internal information provided through the local reference information DB 103 that is located inside of the electronic device 100 as shown in FIG. 1, or external information provided through the remote reference information DB 103 that is located remote from the electronic device 100 as shown in FIG. 1. As an example, face recognition may make reference to an external reference face DB in order to recognize authorized faces and identify different faces. However, a Quick Response (QR) code may generally have internal reference data of the electronic device because the electronic device needs only some specific rules to recognize the QR code in a database, and in normal cases, does not have to be dynamically updated.

The localization unit 230 may localize a recognized target object, that is, calculate the initial pose of a recognized target object. Subsequently, the tracking unit 240 may dynamically calculate a pose of a target object to keep track of the object, and initial information for estimating a pose of the object is derived from an output from the localization unit 230. Finally, the tracking unit 240 may have a basic output of recognition information and localization information including an object pose.

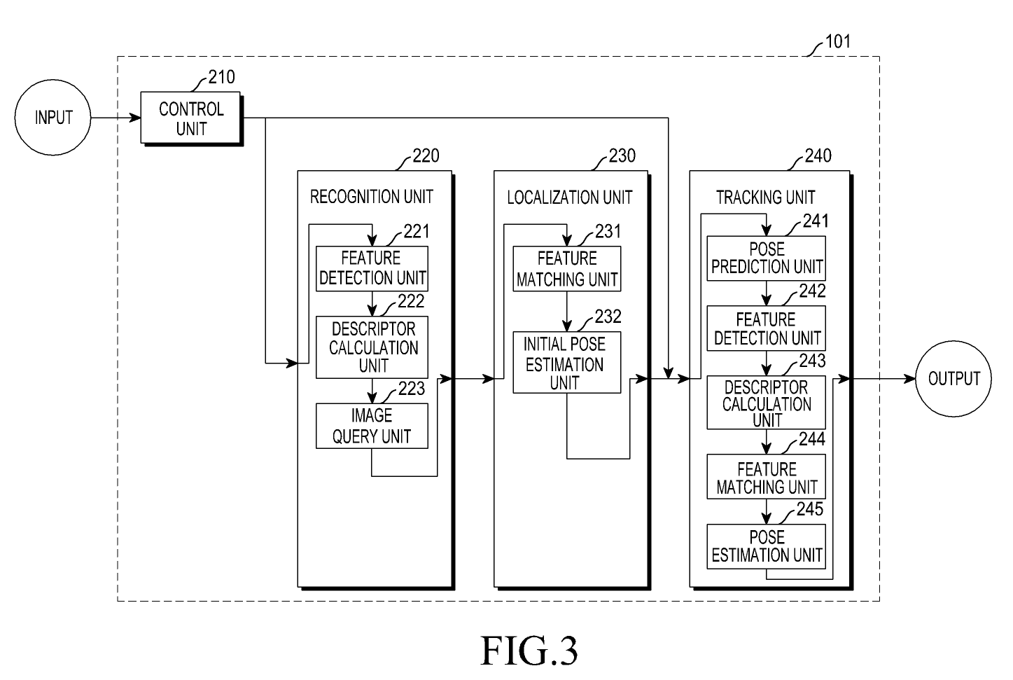

FIG. 3 illustrates a detailed structure of an AR processing unit according to an embodiment of the present disclosure. As an example, detailed functional units for each processing block included in the AR processing unit of FIG. 2 may be as shown in FIG. 3.

Referring to FIG. 3, the recognition unit 220 may include a feature detection unit 221, a descriptor calculation unit 222, and an image query unit 223.

When image data is input, the feature detection unit 221 may detect features in the input image data. The feature detection unit 221 may transmit the detected features to the descriptor calculation unit 222.

The descriptor calculation unit 222 may calculate and generate descriptors by using the detected features, received from the feature detection unit 221, and may transmit the generated descriptors to the image query unit 223.

The descriptor calculation unit 222 may be configured to recognize one or more objects on the digital image, and may determine descriptors to be used to recognize the objects according to various embodiments of the present disclosure.

In order to determine a descriptor to be used for object recognition, the descriptor calculation unit 222 may use at least some of the position, orientation, and/or scale of a feature on the image to determine the descriptor.

In order to determine a descriptor to be used for object recognition, the descriptor calculation unit 222 may determine intensity gradients of pixels located within a region around the feature. The descriptor calculation unit 222 may determine the intensity gradients of pixels with respect to two or more fixed non-orthogonal orientations different from the orientation of the feature. The descriptor calculation unit 222 may convert the intensity gradients, determined with respect to the fixed orientations, to those corresponding to the orientation of the feature.

The descriptor calculation unit 222 may set a region around the feature, which includes sub-regions divided with respect to the orientation of the feature and an orientation orthogonal thereto, and the divided sub-regions may overlap each other at their boundaries.

The image query unit 223 may detect at least one reference image data corresponding to the input image data in the local reference information DB 103 or the remote reference image information DB 440 by using the calculated descriptors, received from the descriptor calculation unit 220, and may recognize an object on the input image data through the detected at least one reference image data.

The localization unit 230 may calculate the initial pose of an object identified through feature detection in the input image data, that is, perform localization of a recognized object. The localization unit 230 may include a feature matching unit 231 and an initial pose estimation unit 232.

The feature matching unit 231 may perform a matching procedure for the features by using the calculated descriptors, received from the recognition unit 220, and may transmit matching information for the features to the initial pose estimation unit 232.

The initial pose estimation unit 232 may estimate the initial pose of an object included in the input image data through the matching information for the features, received from the feature matching unit 231.

The tracking unit 240 may dynamically track object pose changes in image data input in sequence.

The tracking unit 240 may obtain initial information, by which the initial pose of an object included in input image data may be estimated, from the localization unit 230 and subsequently keep tracking of the object in image data received in sequence to dynamically calculate changes in the pose of the object. The tracking unit 240 may output recognition information representing the type of an object and local information representing the pose of the object in each of input image data received in sequence.

The tracking unit 240 may include an object pose prediction unit 241, a feature detection unit 242, a descriptor calculation unit 243, a feature matching unit 244, and a pose estimation unit 245.

The object pose prediction unit 241 may predict the pose of an object in a next input image data through the pose of the object, estimated in each of at least one previously input image data.

The feature detection unit 242 may detect features in input image data that are received in sequence after the initial pose estimation of the object included in the input image data, and may transmit the detected features to the descriptor calculation unit 243.

The descriptor calculation unit 243 may calculate descriptors by using the features of the input image data, received from the feature detection unit 242, and may transmit the calculated descriptors to the feature matching unit 244.

The feature matching unit 244 may perform a matching procedure for the features by using the calculated descriptors, received from the descriptor calculation unit 243, and may transmit matching information for the features to the pose estimation unit 245.

The pose estimation unit 245 may dynamically estimate object pose changes in each of the at least one image data received in sequence by using the matching information for the features, received from the feature matching unit 244, and may output recognition information representing the type of an object included in each input image data and local information representing the pose of the object.

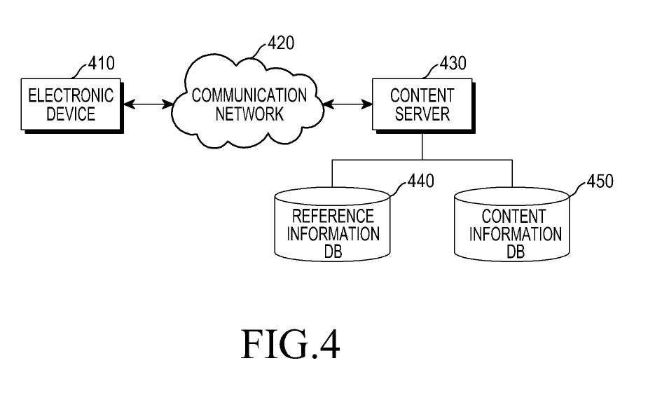

FIG. 4 illustrates a system according to an embodiment of the present disclosure.

Referring to FIG. 4, the system according to an embodiment of the present disclosure may include an electronic device 410, a communication network 420, and a content server 430.

The electronic device 410 may include at least some or all of the functions of the electronic device 100 as described above in FIG. 1.

The communication network 420 may be implemented regardless of its communication type such as wired communication or wireless communication, and may be implemented as various communication networks including a Personal Area Network (PAN), a Local Area Network (LAN), a Metropolitan Area Network (MAN), a Wide Area Network (WAN), and the like. Further, the communication network 420 may be a known World Wide Web (WWW), and may use a wireless transmission technology employed in short range communication such as Infrared Data Association (IrDA) or Bluetooth. Further, the communication network 420 may include a cable broadcasting communication network, a terrestrial broadcasting communication network, a satellite broadcasting communication network, or the like for receiving a broadcasting signal.

The content server 430 may perform at least one of a function of recognizing an object, a function of localization of the recognized object, and a function of tracking the object according to various embodiments of the present disclosure. For example, various functions according to various embodiments of the present disclosure, which may be processed in the electronic device 100 of FIG. 1, may be processed by the electronic device 410 and the content server 430 of FIG. 4 in a distributed manner.

Further, the content server 430 may include a reference information DB 440 and a content information DB 450, and may provide reference information stored in the reference information DB 440 and content information stored in the content information DB 450 to the electronic device 410 at the request of the electronic device 410.

In various embodiments of the present disclosure, each functional unit and each module may means a functional or structural coupling of hardware for implementing the technical idea of various embodiments of the present disclosure and software for operating the hardware. As an example, each functional unit may mean a logical unit of a predetermined code and a hardware resource for performing the predetermined code, and a person having ordinary skill in the art will easily appreciate that each functional unit does not necessarily mean a physically coupled code or a kind of hardware.

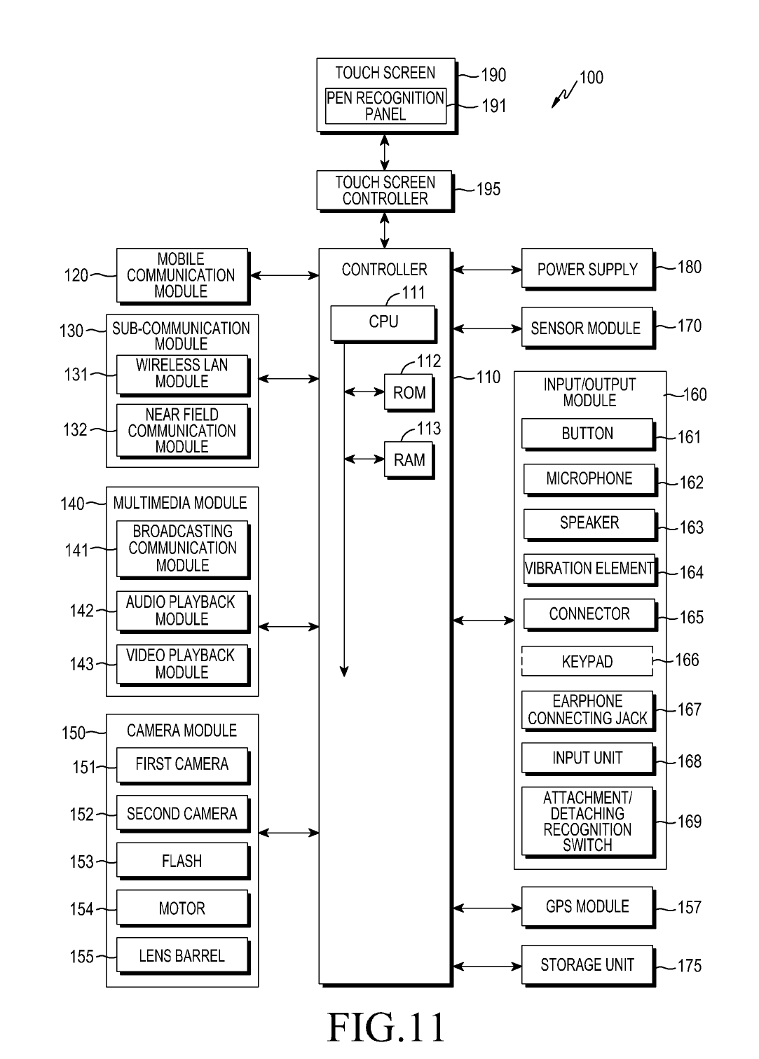

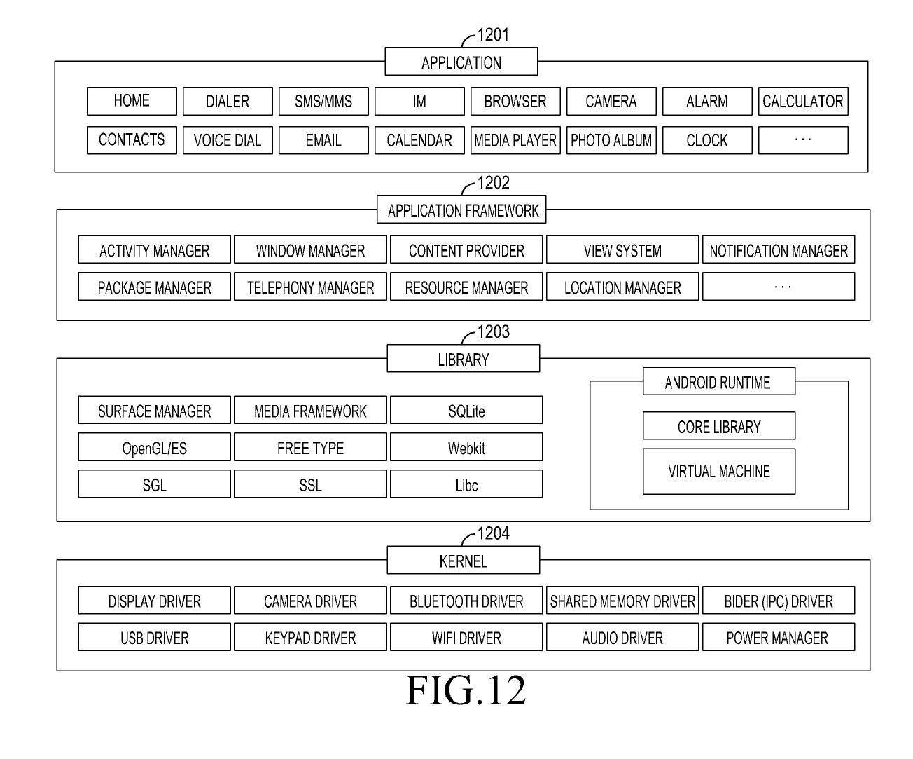

Further, the implementations described in connection with one or more of FIGS. 1 to 4 may be at least a part of a system or device as shown in FIG. 11 and/or FIG. 12. The above drawings and description thereof provide various implementations, and are not intended to limit the scope of the present disclosure. The implementations described and shown above may be adjusted to apply to various embodiments of the pre sent disclosure. Those skilled in the art will appreciate that one or more constituent elements described and/or shown above may be omitted or modified in various embodiments of the present disclosure. Additionally, other constituent elements may be added to various embodiments of the present disclosure, if necessary. In various embodiments of the present disclosure, one or more methods, steps, or algorithms may be performed or executed using one or more constituent elements described and/or shown in the above implementations.

Hereinafter, according to an embodiment of the present disclosure, a method of recognizing an object through the recognition unit 220 and the localization unit 230 and calculating an initial pose of an object included in an image will be described in detail with reference to FIGS. 5 to 10.

A recognition process of AR may be divided into a query step for identifying which object an image includes and a localization step for calculating an initial pose of an object recognized as a result of the query step. In the embodiment of the present disclosure, only data required for each step is loaded and used so that a method by which quick and accurate object recognition and pose estimation are available with a small size of a memory is initiated.

FIG. 5 is a flowchart illustrating a process of operating an electronic device according to an embodiment of the present disclosure.

Referring to FIG. 5, when an image has been input in operation 501, a feature point in the input image may be detected and a descriptor may be generated in operation 503.

In operation 505, identification data is only loaded in the memory for a target object determination so that the efficient use of memory may be improved. In operation 507, a target object may be determined by recognizing an object from the detected feature point and loaded identification data (for example, K-Dimensional (KD) tree data).

A reference descriptor is loaded in the memory in operation 509 and a pose of the target object may be determined by using the loaded reference descriptor in operation 511.

FIG. 6 is a flowchart illustrating a procedure of operating an electronic device according to an embodiment of the present disclosure. FIG. 6 is a detailed embodiment of FIG. 5.

Referring to FIG. 6, first of all, an electronic device according to an embodiment of the present disclosure may load a KD tree for a query step from a local storage or a server (e.g. a content server) to a memory in operation 603. According to various embodiments of the present disclosure, a KD tree for a dark feature and a KD tree for a bright feature may be divided and loaded. Meanwhile, according to the embodiment of the present disclosure, in operation 603, descriptors for the reference features may be not loaded so that efficient use of a memory and a processing speed may be improved.

When image data has been input in operation 601, a feature may be detected from the input image data in operation 605. A method of detecting the feature may be a Flexible Algebraic Scientific Translator (FAST), an Adaptive and Generic Accelerated Segment Test (AGAST), a Moravec corner detector, a Harris & Stephens corner detector, Smallest Univalue Segment Assimilating Nucleus (SUSAN), or the like but the present disclosure is not limited to these methods. Further, a description for the detected features is performed so that a descriptor may be generated. Various methods such as BRIEF, SIFT, SURF, FREAK, and the like may be applied as a method for the description but the present disclosure is not limited to the methods.

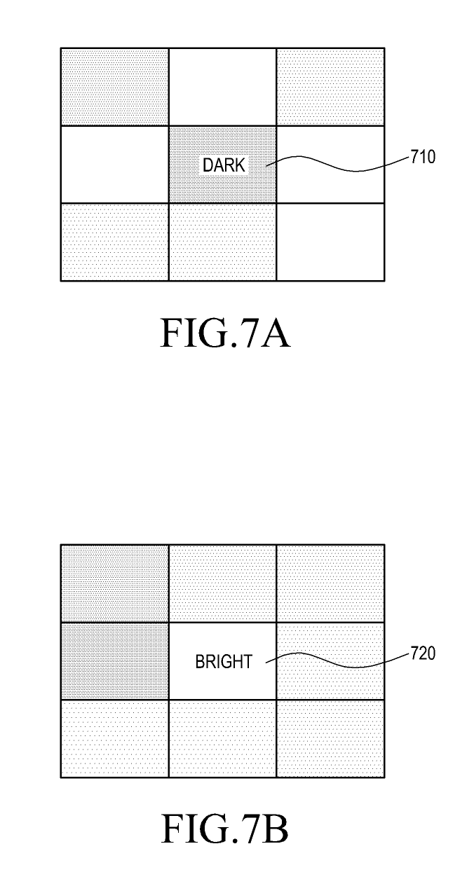

In addition, according the various embodiments of the present disclosure, with respect of the detected features, a bright attribute may be assigned to a feature which is bright in comparison with surrounding pixels and a dark attribute may be assigned to a feature which is dark in comparison with surrounding pixels. FIG. 7A illustrates a feature 710 having a dark attribute according to an embodiment of the present disclosure and FIG. 7B illustrates a feature 720 having a bright attribute according to an embodiment of the present disclosure.

In operation 607, the features may pass through a masking process before being used in the query step. Since the query step is for finding a new object, an area for an object which has been previously recognized and tracked on the whole image may be excluded. Therefore, features detected in an area of the tracked object among all features may be masked and excluded in a matching procedure.

According to the embodiment of the present disclosure, features which are not masked in operation 607 are matched with features of reference objects by using KD trees. According to various embodiments of the present disclosure, the KD trees may be used by being divided into a KD tree for a bright feature matching and a KD tree for a dark feature matching.

When the feature has a ‘bright’ attribute in operation 609, the feature does not need to be matched with features which have a ‘dark’ attribute. Therefore, the features may be compared using a bright KD tree in operation 611. Otherwise, when the feature has a ‘dark’ attribute in operation 609, the feature does not need to be matched with features which have the ‘bright’ attribute. Accordingly, the features may be compared using a dark KD tree in operation 613. According to the embodiment of the present disclosure, when the features are matched depending on the bright and dark attribute, a probability in which the feature is normally matched may be higher than a probability in which the features are matched by targeting all features.

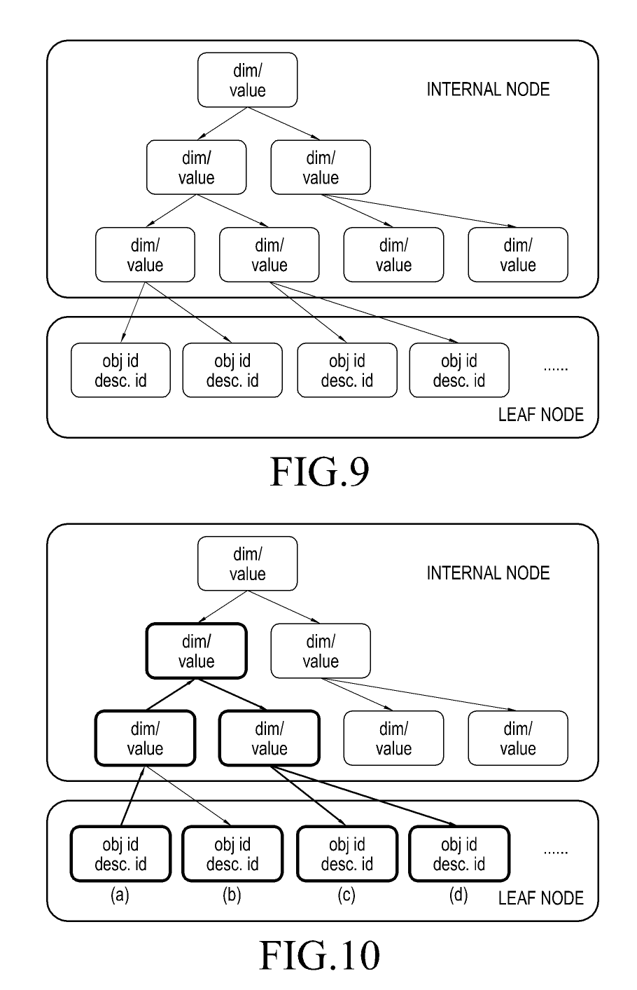

FIG. 9 illustrates a KD tree structure according to an embodiment of the present disclosure.

Referring to FIG. 9, the feature descriptor as described above is a multi-dimensional vector. An internal node of the KD tree may include a dimension to be compared and a value to be compared. For example, when a dimension to be compared corresponds to the fourth and a value to be compared is 0.5, a fourth value of the input feature descriptor is compared with 0.5. As a result of the comparison, when the fourth value of input feature descriptor is less than 0.5, the feature descends to a left child node. When the fourth value of input feature descriptor is more than 0.5, the feature descends to a right child node. The process as described above may be repeated and performed until reaching a leaf node. An ID of a reference object to which a final matched feature descriptor belongs is mapped in each leaf node.

In operation 615, the frequency of corresponding IDs in a histogram may be increased by using an ID of the found object. When all features which are not masked are matched by using the KD tree and a frequency of corresponding object IDs increases, a histogram for each object ID may be generated. Object IDs having values larger than or equal to a specific threshold in the histogram may be a result of the query step.

A probability that the found objects exist in a current image is high. Therefore, with respect to each object, whether the object actually exists in the image is verified through the localization step and a procedure of calculating the initial pose of the object is performed.

A method of increasing the frequency of the histogram has been discussed above. According to various embodiments of the present disclosure, several modified various embodiments may exist in the method of increasing the frequency of the histogram.

FIG. 10 illustrates a KD tree structure in which a nearest neighbor is displayed according to an embodiment of the present disclosure.

Referring to FIG. 10, when an input feature reaches a specific leaf node in the KD tree, n number of nearest neighbor nodes other than a corresponding node may be considered. When a number of the reference objects increases, a success rate of accurate matching may be gradually reduced. Therefore, when features which have similar values of surrounding nodes are found and reflected in the histogram according to various embodiments of the present disclosure, rather than an object being recognized through one leaf node, a more accurate result of the query may be obtained.

The method of considering n number of nearest neighbor may be illustrated as illustrated in FIG. 10. Referring to FIG. 10, when an input feature reaches a leaf node a and three nearest neighbors with respect to the leaf node a are considered, the input feature ascends twice to a parent node and child nodes which are under the parent node become three nearest neighbors for example, leaf nodes b, c, d, or the like. In FIG. 10, since almost common internal node tests have been passed before reaching the leaf nodes, descriptors of the leaf nodes a,b,c, and d may be similar each other.

When four leaf nodes are determined, an ID of an object corresponding to each leaf node increases in the histogram. According to various embodiments of the present disclosure, the increasing method may be a method of giving equivalent weight to each ID and a method of giving a higher weight to each ID as a distance of leaf nodes is near (e.g., to a leaf node having a short path in the KD tree). In operation 617, an ID of the most probable object may be determined by the histogram.

Therefore, when the query step has been completed, the localization step may be performed through operations 619 to 625.

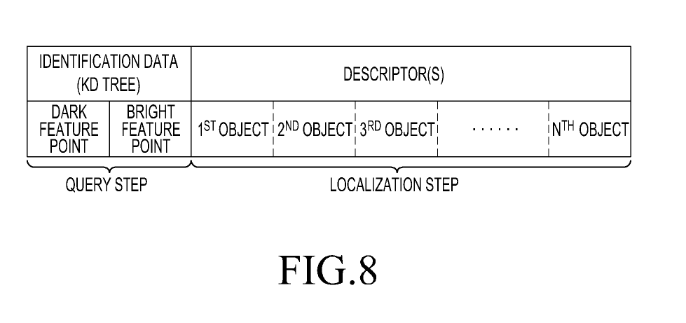

FIG. 8 illustrates data fields stored in a memory according to an embodiment of the present disclosure.

Referring to FIG. 8, identification data (e.g. KD tree) for the query step and descriptors for each object are divided and stored in a memory and a storage. According to an embodiment of the present disclosure, a descriptor which corresponds to an ID of a firstly found object is only loaded and used in the memory in operation 619 so that memory use efficiency and a processing speed may be improved.

In operation 621, the descriptor loaded in the memory may be directly used for making the KD tree for matching in the localization step. According to the embodiment of the present disclosure, two types of KD trees may be generated by considering a bright and dark attribute for a higher matching rate.

Further, input features which are not masked may be again matched to reference features through the KD tree. While a KD tree used in the query step causes the input features which are not masked to be matched to features extracted from all reference objects, a KD tree used in the localization step causes the input features which are not masked to be matched to features in one object. Therefore, the KD tree in the localization step makes a matching target to be limited to one object so that accurate feature matching may be performed with a high rate.

A matching pair between input features and reference features may be generated by the feature matching. Among the matching pairs, a pair normally matched and a pair wrongly matched may exist. In order to filter the pair wrongly matched, methods such as RANdom SAmple Consensus (RANSAC), Progressive SAmple Consensus (PROSAC), Maximum Likelihood Estimator SAmple Consensus (MLESAC), M-estimator, and the like may be used. When the pair normally matched is determined, a pose of the object may be calculated from the pair in operation 623. In the localization step, various methods such as p3p algorithm, and the like may be used but various embodiments of the present disclosure are not limited to a specific method. When a matching pair has a value less than a specific threshold, a possibility that a corresponding object does not actually exist on the image is high. Accordingly, the object may be ignored.

After finishing a pose estimation procedure, when there is an object on which the localization step has not been performed among objects found in the query step, the localization step may be performed again for the corresponding object. Before performing the localization step, features which belong to the found object may be masked in operation 625.

As described above, according to the embodiment of the present disclosure, the electronic device 100 which recognizes an object and calculates an initial pose of the object may be a device including a control unit (processor) and refer to a camera, a portable device, a mobile terminal, a communication terminal, a portable communication terminal, a portable mobile terminal, or the like. As an example, the electronic device may be a digital camera, a smart phone, a mobile phone, a gaming machine, a TV, a display device, a head unit for a motor vehicle, a notebook computer, a laptop computer, a tablet computer, a PMP, a PDA, a navigation device, an ATM for banking, a POS device of a shop, or the like. Further, the electronic device of the present disclosure may be a flexible device or a flexible display unit.

Hereinafter, a detailed structure of an electronic device 100 to which various embodiments of the present disclosure may be applied will be described by way of example with reference to FIG. 11.

FIG. 11 illustrates a detailed structure of an electronic device 100 according to an embodiment of the present disclosure. Referring to FIG. 11, the electronic device 100 may include at least one of a control unit 110, a mobile communication module 120, a sub communication module 130, a multimedia module 140, a camera module 150, an input/output module 160, a sensor module 170, a state indicator 171, a storage unit 175, a power supply unit 180, and a touch screen 190.

More specifically, the electronic device 100 may be connected with an external electronic device (not shown) by using at least one of the mobile communication module 120, a connector 165, and an earphone connecting jack 167. Further, the electronic device 100 may be wired or wirelessly connected with another portable device or another electronic device, for example, one of a mobile phone, a smart phone, a tablet PC, a desktop PC, and a server.

The mobile communication module 120, a sub communication module 130, and a broadcasting communication module 141 of the multimedia module 140 may be collectively called a communication unit. The sub communication module 130 may include at least one of a wireless LAN module 131 and a near field communication module 132. The multimedia module 140 may include at least one of an audio playback module 142 and a video playback module 143. The camera module 150 may include at least one of a first camera 151 and a second camera 152. Also, the camera module 150 may further include a flash 153, a motor 154, and a lens barrel 155. The input/output module 160 may include at least one of a button 161, a microphone 162, a speaker 163, a vibration element 164, the connector 165, and a keypad 166.

The control unit 110 may include a CPU 111, a Read Only Memory (ROM) 112 storing a control program for controlling the electronic device 100, and a Random Access Memory (RAM) 113 used as a storage area for storing external input signals or data of the electronic device 100 or for work performed in the electronic device 100. The CPU 111 may include a single core, a dual core, a triple core CPU, or a quad core. The CPU 111, the ROM 112, and the RAM 113 may be connected to each other through an internal bus.

Further, the control unit 110 may control at least one of the mobile communication module 120, the multimedia module 140, the camera module 150, the input/output module 160, the sensor module 170, the storage unit 175, the power supply unit 180, the touch screen 190, and a touch screen controller 195.

Further, the control unit 110 may detect a user input event such as a hovering event occurring when an input unit 168 approaches the touch screen 190 or is located close to the touch screen 190. Further, the control unit 110 may detect various user inputs received through the camera module 150, the input/output module 160, and the sensor module 170, as well as the input unit 190. The user input may include various types of information input into the device 100, such as a gesture, a voice, pupil movement, iris recognition, and a bio signal of a user, as well as a touch. The control unit 110 may control the device 100 such that a predetermined operation or function corresponding to the detected user input is performed within the device 100. Further, the control unit 110 may output a control signal to the input unit 168 or the vibration element 164. Such a control signal may include information on a vibration pattern, and the input unit 168 or the vibration element 164 generates a vibration according to the vibration pattern.

Further, the electronic device 100 may include at least one of the mobile communication module 120, the wireless LAN module 131, and the short range communication module 132, depending on its capability.

Under the control of the control unit 110, the mobile communication module 120 allows the electronic device 100 to be connected with an external electronic device through mobile communication by using at least one (one or a plurality of) antenna (not shown). The mobile communication module 120 may transmit/receive a wireless signal for a voice call, a video call, a Short Message Service (SMS), or a Multimedia Message Service (MMS) to/from a mobile phone (not shown), a smart phone (not shown), a tablet PC (not shown), or another electronic device (not shown) having a phone number input into the electronic device 100.

The sub communication module 130 may include at least one of the wireless LAN module 131 and the short range communication module 132. As an example, the sub communication module 130 may include only the wireless LAN module 131, only the short range communication module 132, or both the wireless LAN module 131 and the short range communication module 132.

Under the control of the control unit 110, the wireless LAN module 131 may be connected to the Internet in a place where a wireless Access Point (AP) (not shown) is installed. The wireless LAN module 131 may support the IEEE802.11x standards of the Institute of American Electrical and Electronics Engineers (IEEE). Under the control of the control unit 110, the short range communication module 132 may wirelessly perform near field communication between the electronic device 100 and an external electronic device. The short range communication scheme may include Bluetooth, IrDA, Wi-Fi direct communication, Near Field Communication (NFC), and the like.

Under the control of the control unit 110, the broadcasting communication module 141 may receive a broadcasting signal (e.g., a TV broadcasting signal, a radio broadcasting signal, or a data broadcasting signal) and broadcasting supplement information (e.g., Electric Program Guide (EPG) or Electric Service Guide (ESG)), transmitted from a broadcasting station, through a broadcasting communication antenna (not shown).

The multimedia module 140 may include the audio playback module 142 or the video playback module 143. Under the control of the control unit 110, the audio playback module 142 may play back a stored or received digital audio file (e.g., a file having a file extension of mp3, wma, ogg, or way). Under the control of the control unit 110, the video playback module 143 may play back a stored or received digital video file (e.g., a file having a file extension of mpeg, mpg, mp4, avi, mov, or mkv). The multimedia module 140 may be integrated in the control unit 110.

The camera module 150 may include at least one of the first camera 151 and the second camera 152 that photographs a still image, a video, or a panorama picture under the control of the control unit 110. Further, the camera module 150 may include at least one of the lens barrel 155 that performs a zoom-in/out for photographing a subject, the motor 154 that controls the movement of the lens barrel 155, and the flash 153 that provides an auxiliary light source required for photographing a subject. The first camera 151 may be disposed on the front surface of the electronic device 100, and the second camera 152 may be disposed on the back surface of the electronic device 100.

The input/output module 160 may include at least one of at least one button 161, at least one microphone 162, at least one speaker 163, at least one vibration element 164, the connector 165, the keypad 166, the earphone connecting jack 167, and the input unit 168. However, the input/output module 160 is not limited thereto, and may include a mouse, a trackball, a joystick, or a cursor control such as cursor direction keys to control the movement of a cursor on the touch screen 190.

The button 161 may be formed on the front surface, side surface, or back surface of the housing (or case) of the electronic device 100, and may include at least one of a power/lock button, a volume button, a menu button, a home button, a back button, and a search button. Under the control of the control unit 110, the microphone 162 may receive an input voice or sound to generate an electric signal. Under the control of the control unit 110, the speaker 163 may output sounds corresponding to various signals or data (e.g., wireless data, broadcasting data, digital audio data, digital video data, etc.) to the outside of the electronic device 100. The speaker 163 may output sounds corresponding to functions performed by the electronic device 100 (e.g., a button operation sound, a ringtone, and a counterpart's voice corresponding to a voice call). One speaker 163 or a plurality of speakers 163 may be formed on an appropriate position or positions of the housing of the electronic device 100.

Under the control of the control unit 110, the vibration element 164 may convert an electric signal into a mechanical vibration. As an example, when the electronic device 100 in a vibration mode receives a voice or video call from another device (not shown), the vibration element 164 is operated. One vibration element 164 or a plurality of vibration elements 164 may be formed within the housing of the electronic device 100. The vibration element 164 may be operated in correspondence with a user input through the touch screen 190.

The connector 165 may be used as an interface for connecting the electronic device 100 with an external electronic device or a power source (not shown). The control unit 110 may transmit data stored in the storage unit 175 of the electronic device 100 to or receive data from an external electronic device through a wired cable connected to the connector 165. The electronic device 100 may receive power from a power source or charge a battery (not shown) by using the power source through the wired cable connected to the connector 165.

The keypad 166 may receive a key input for the control of the electronic device 100 from a user. The keypad 166 may include a physical keypad (not shown) formed in the electronic device 100 or a virtual keypad (not shown) displayed on the touch screen 190. The physical keypad formed in the electronic device 100 may be omitted depending on the capability or structure of the electronic device 100. An earphone (not shown) may be inserted into the earphone connecting jack 167 to be connected with the electronic device 100.

The input unit 168 may be kept inserted into the inside of the electronic device 100, and may be withdrawn or separated from the electronic device 100 when being used. An attachment/detachment recognition switch 169 that is operated in correspondence with the attachment/detachment of the input unit 168 may be provided in one area within the electronic device 100, into which the input unit 168 is to be inserted, and the attachment/detachment recognition switch 169 may output signals corresponding to the insertion and separation of the input unit 168 to the control unit 110. The attachment/detachment recognition switch 169 may be configured to be directly/indirectly contacted with the input unit 168 when the input unit 168 is inserted. Accordingly, the attachment/detachment recognition switch 169 may generate a signal corresponding to the insertion or separation (that is, a signal indicating the insertion or separation of the input unit 168), based on whether the attachment/detachment recognition switch 169 is contacted with the input unit 168, and output the generated signal to the control unit 110.

The sensor module 170 may include at least one sensor for detecting a state of the electronic device 100. As an example, the sensor module 170 may include at least one of a proximity sensor for detecting whether a user approaches the electronic device 100, a light sensor (not shown) for detecting the amount of ambient light of the electronic device 100, a motion sensor (not shown) for detecting motion (e.g., rotation, acceleration, or vibration) of the electronic device 100, a geo-magnetic sensor for detecting the point of the compass of the electronic device 100 by using the Earth's magnetic field, a gravity sensor for detecting the direction of gravity action, an altimeter for detecting altitude by measuring atmospheric pressure, and a GPS module 157.

The GPS module 157 may receive radio waves from a plurality of GPS satellites (not shown) on the Earth's orbits and calculate a position of the electronic device 100 by using the time of arrival from each of the GPS satellites to the electronic device 100.

Under the control of the control unit 110, the storage unit 175 may store a signal or data input/output according to an operation of the communication module 120, the multimedia module 140, the camera module 150, the input/output module 160, the sensor module 170, or the input device 190. Further, according to an embodiment of the present disclosure, the storage unit 175 may store a variety of state information and setting information of the electronic device 100.

The storage unit 175 may store a control program and applications for controlling the electronic device 100 or the control unit 110. One of the control program and applications may be a messenger client application installed according an embodiment of the present disclosure.

The term “storage unit” may be used as a term that refers to any data storage device such as the storage unit 175, the ROM 112 or the RAM 113 within the control unit 110, or a memory card (e.g., an SD card or a memory stick) mounted in the electronic device 100. The storage unit 175 may include a non-volatile memory, a volatile memory, or a Hard Disk Drive (HDD), or a Solid State Drive (SSD).

Further, the storage unit 175 may store applications having various functions such as a navigation function, a video call function, a game function, and a time based alarm function, images for providing a GUI related to the applications, databases or data related to a method of processing user information, a document, and a touch input, background images (a menu screen, an idle screen or the like) or operating programs required for driving the electronic device 100, and images photographed by the camera module 150.

Further, the storage unit 175 is a machine (e.g., computer)-readable medium, and the term “machine-readable medium” may be defined as a medium for providing data to a machine so as for the machine to perform a specific function. The storage unit 175 may include a non-volatile medium and a volatile medium. All such media should be of a type in which commands transferred by the media may be detected by a physical mechanism that reads the commands into a machine.

The computer readable storage medium includes, but is not limited to, at least one of a floppy disk, a flexible disk, a hard disks, a magnetic tape, a Compact Disc Read-Only Memory (CD-ROM), an optical disk, a punch card, a paper tape, a RAM, a Programmable Read-Only Memory (PROM), an Erasable PROM (EPROM), and a Flash-EPROM. The computer readable storage medium includes, but is not limited to, at least one of a floppy disk, a flexible disk, a hard disks, a magnetic tape, a CD-ROM, an optical disk, a punch card, a paper tape, a RAM, a PROM, an EPROM, a Flash-EPROM and an embedded Multi Media Card (eMMC).

Under the control of the control unit 110, the power supply unit 180 may supply power to one battery or a plurality of batteries disposed in the housing of the electronic device 100. The one battery or the plurality of batteries supply power to the electronic device 100. Further, the power supply unit 180 may supply power, input from an external power source through a wired cable connected to the connector 165, to the electronic device 100. Further, the power supply unit 180 may supply power, wirelessly input from an external power source through a wireless charging technology, to the electronic device 100.

The electronic device 100 may include at least one touch screen 190 that provides a user with GUIs corresponding to various services (e.g., a phone call, data transmission, broadcasting, and photography). The touch screen 190 may output an analog signal corresponding to at least one user input into a GUI to the touch screen controller 195.

The touch screen 190 may receive at least one user input through a user's body (e.g., fingers including a thumb) or the input unit 168 (e.g., a stylus pen or an electronic pen). The touch screen 190 may be implemented in, for example, a resistive type, a capacitive type, an infrared type, an acoustic wave type, or a combination thereof

Further, the touch screen 190 may include at least two touch panels capable of detecting a touch or approach of a finger or the input unit 168 in order to receive an input by each of the finger and the input unit 168. The at least two touch panels may output different output values to the touch screen controller 195, and the touch screen controller 195 may differently recognize the values input into the at least two touch screen panels to identify whether the input from the touch screen 190 is an input by a finger or an input by the input unit 168.

Further, an input into the touch screen 190 is not limited to a touch between the touch screen 190 and a user's body or a touchable input means, but may include a non-touch (e.g., the interval between the touch screen 190 and a user's body or a touchable input means is 1 mm or shorter). A threshold interval for detecting an input in the touch screen 190 may vary according to the capability or structure of the electronic device 100.

The touch screen controller 195 converts an analog signal input from the touch screen 190 into a digital signal, and transmits the converted digital signal to the controller 110. The control unit 110 may control the touch screen 190 by using the digital signal received from the touch screen controller 195. The touch screen controller 195 may determine a user input position and a hovering interval or distance by detecting a value (e.g., a current value, etc.) output through the touch screen 190, and may convert the determined distance value into a digital signal (e.g., a Z coordinate) and provide the digital signal to the control unit 110. Further, the touch screen controller 190 may detect a pressure applied to the touch screen 190 by a user input means by detecting a value (e.g., a current value, etc.) output through the touch screen 190, and may convert the detected pressure value into a digital signal and provide the converted digital signal to the control unit 110.

The methods according to various embodiments of the present disclosure as described above may be implemented in the form of program commands that may be executed through various computer means, and may be stored in a computer-readable recording medium. The computer-readable recording medium may include a program instruction, a data file, a data structure, and the like, solely or in combination. The program instruction recorded in the computer-readable recording medium may be either one that is specifically designed and configured for the present disclosure or one that is well-known to and used by a person having ordinary skill in the art of computer software.

Further, the methods according to various embodiments of the present disclosure may be implemented in the form of a program instruction and stored in the storage unit 175 of the above-described electronic device 100, and the program instruction may be temporarily stored in the RAM 113 included in the control unit 110 so as to execute the methods according to various embodiments of the present disclosure. Accordingly, the control unit 110 may control hardware components included in the device 100 in response to the program instruction of the methods according to various embodiments of the present disclosure, may temporarily or continuously store data generated while performing the methods according to various embodiments of the present disclosure in the storage unit 175, and may provide UIs required to perform the methods according to various embodiments of the present disclosure to the touch screen controller 195.

FIG. 12 illustrates a software architecture of a computer device to which various embodiments of the present disclosure are applicable. Referring to FIG. 12, the software architecture of an electronic device to which various embodiments of the present disclosure is applicable may be classified into an application level 1201, an application framework level 1202, a library level 1203, a kernel level 1204, and the like.

The application level 1201 may include Home, Dialer, SMS/MMS, IM, Browser, Camera, Alarm, Calculator, Contacts, Voice Dial, Email, Calendar, Media Player, Photo Album, Clock, and the like. The application framework level 1202 may include Activity Manager, Window Manager, Content Provider, View System, Notification Manager, Package Manager, Telephony Manager, Resource Manager, Location Manager, and the like.

The library level 1203 may include Surface Manager, Media Framework, SOLite, OpenGL/ES, Free Type, Webkit, SGL, SSL, Libc, Android Runtime (Core Library, Virtual Machine, etc.), and the like. The kernel level 1204 may include Display Driver, Camera Driver, Bluetooth Driver, Shared Memory Driver, Binder (IPC) Driver, USB Driver, Keypad Driver, WiFi Driver, Audio Driver, Power Manager, and the like.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating an electronic device, the method comprising:
recognizing at least one object from a digital image,
wherein the recognizing of the object comprises:
generating at least one descriptor from the digital image;
determining an object in the digital image on a basis of at least one part of the at least one descriptor and identification data corresponding to at least one reference object; and
determining a pose of the object on a basis of at least one part of a reference descriptor corresponding to the determined object and the at least one descriptor.

2. The method as claimed in claim 1, wherein the identification data is indexed by a tree structure.

3. The method as claimed in claim 2, wherein the tree structure comprises one or more selected tree structures among a K-Dimensional (KD) tree, a randomized tree, and a spill tree.

4. The method as claimed in claim 1, wherein the determining of the object further comprises loading the identification data in a memory and the loading of the identification data comprises loading identification data indexed by a tree structure.

5. The method as claimed in claim 1, wherein the reference descriptor is indexed by a tree structure.

6. The method as claimed in claim 5, the tree structure comprises one or more selected tree structures among a K-Dimensional (KD) tree, a randomized tree, and a spill tree.

7. The method as claimed in claim 1, wherein the determining of the pose of the object comprises:
loading reference descriptors corresponding to the determined object in a memory; and
indexing the reference descriptors by a K-Dimensional (KD) tree structure.

8. The method as claimed in claim 1, wherein the descriptor and the reference descriptor have an attribute given based on a relationship between a feature corresponding to each descriptor and at least one adjacent pixel which is adjacent to a corresponding feature.

9. The method as claimed in claim 8, wherein the attribute represents a relative brightness of the corresponding feature in comparison with the at least one adjacent pixel.

10. The method as claimed in claim 1, wherein the determining of the object in the image comprises determining an object corresponding to an identifier coinciding with one of a set number of target descriptors and a larger number of target descriptors among identifiers corresponding to leaf nodes in a tree structure which have been reached according to a path tracked for each target descriptor as the object.

11. The method as claimed in claim 1, wherein the determining of the object comprises determining an object corresponding to an identifier coinciding with one of a set number of target descriptors and a larger number of target descriptors among identifiers corresponding to leaf nodes of a tree structure which have been reached according to a path tracked for each target descriptor and identifiers corresponding to a neighbor leaf node of the tree structure branched from an upper node of the tree structure having a set node distance from a corresponding leaf node of the tree structure as the object.

12. The method as claimed in claim 11, wherein the determining of the at least one target object comprises applying different weights to an identifier corresponding to the leaf node of the tree structure and an identifier corresponding to the neighbor leaf node of the tree structure.

13. The method as claimed in claim 12, wherein the determining of the at least one target object comprises applying different weights to the identifier corresponding to the neighbor leaf node of the tree structure depending on a node distance from the leaf node of the tree structure.

14. The method as claimed in claim 1, wherein the generating of the at least one target descriptor comprises extracting features in a remaining area except for an area where an object which is being tracked is located and generating at least one target descriptor.

15. The method as claimed in claim 1, wherein the generating of the at least one target object comprises generating target descriptors for the remaining features except for features extracted in an area where an object which is being tracked is located among features extracted from the target image.

16. The method as claimed in claim 1, further comprising:
creating a set type of the identification data by using a loaded reference descriptor,
wherein the determining the pose of the target object comprises determining a pose of the target object based on at least one target descriptor and the created set type of identification data.

17. The method as claimed in claim 16, wherein the creating of the identification data comprises creating a plurality of identification data based on different attributes.

18. The method as claimed in claim 16, wherein the creating of the identification data comprises creating identification data with the tree structure used to determine an identifier of a reference object corresponding to each of the at least one target descriptor.

19. The method as claimed in claim 16, wherein the attribute is an attribute that represents a brightness of a corresponding feature in comparison with adjacent pixels.

20. A method of operating an electronic device, the method comprising:
recognizing an object from a digital image on a basis of object data stored in a database and descriptor data related to each object data,
wherein the recognizing of the object comprises:
determining an object in the image by using the object data; and
determining a pose of the object on a basis of at least one part of one or more descriptors related to the determined object.

21. The method as claimed in claim 20, wherein the determining of the object in the image comprises loading the object data to a memory in the electronic device.

22. The method as claimed in claim 20, wherein the determining of the pose of the object comprises only loading the one or more descriptors related to the determined object to the memory.

23. An electronic device comprising:
a memory configured to store a digital image; and
a processor configured to process the digital image, wherein the processor comprises:
a recognition unit configured to generate at least one descriptor from the digital image and determines an object in the digital image on a basis of at least one part of at least one reference object and identification data corresponding to the at least one descriptor; and
a localization unit configured to determine a pose of the object on a basis of at least one part of a reference descriptor corresponding to the determined object and the at least one descriptor.

24. The electronic device as claimed in claim 23, wherein a target descriptor and the at least one part of the reference descriptor have an attribute given based on a relationship between a feature corresponding to each of the at least one descriptor and at least one adjacent pixel which is adjacent to a corresponding feature.

25. The electronic device as claimed in claim 24, wherein the recognition unit loads identification data having an attribute which is identical to the target descriptor among a plurality of identification data based on different attributes.

26. The electronic device as claimed in claim 24, wherein the localization unit loads a reference descriptor having an attribute which is identical to the target descriptor.

27. The electronic device as claimed in claim 24, wherein the attribute is an attribute for representing a relative brightness of the corresponding feature in comparison with the at least one adjacent pixel.

28. The electronic device as claimed in claim 23, the identification data has a tree structure used to determine an identifier of a reference object corresponding to each target descriptor.

29. The electronic device as claimed in claim 28, wherein the recognition unit determines an object corresponding to an identifier coinciding with one of a set number of target descriptors and a larger number of target descriptors among identifiers corresponding to leaf nodes of a tree structure which have been reached according to a path tracked for each target descriptor as the object.

30. The electronic device as claimed in claim 28, wherein the recognition unit determines an object corresponding to an identifier coinciding with one of a set number of target descriptors and a larger number of target descriptors among identifiers corresponding to leaf nodes of a tree structure which have been reached according to a path tracked for each target descriptor and identifiers corresponding to a neighbor leaf node of the tree structure branched from an upper node of the tree structure having a set node distance from a corresponding leaf node of the tree structure as the object.

31. The electronic device as claimed in claim 30, wherein the recognition unit applies different weights to the identifier corresponding to the leaf node of the tree structure and the identifier corresponding to the neighbor leaf node of the tree structure.

32. The electronic device as claimed in claim 31, wherein the recognition unit applies different weights to the identifier corresponding to the neighbor leaf node of the tree structure depending on a node distance with the leaf node of the tree structure.

33. The electronic device as claimed in claim 28, the identification data has one tree structure among a K-Dimensional (KD) tree, a randomized tree, and a spill tree.

34. The electronic device as claimed in claim 23, wherein the recognition unit extracts features in a remaining area except for an area where an object which is being tracked is located and generates the at least one target descriptor.

35. The electronic device as claimed in claim 23, wherein the recognition unit generates at least one target descriptor for the remaining features except for features extracted in an area where an object which is being tracked is located among features extracted from the target image.

36. The electronic device as claimed in claim 23, wherein the localization unit creates a set type of identification data by using a loaded reference descriptor and determines a pose of the target object based on at least one target descriptor and the created set type of identification data.

37. The electronic device as claimed in claim 36, wherein the localization unit creates a plurality of identification data based on different attributes.

38. The electronic device as claimed in claim 36, wherein the localization unit creates identification data with a tree structure used to determine an identifier of a reference object corresponding to each of the at least one target descriptor.

39. The electronic device as claimed in claim 36, wherein the attribute represents a brightness of the corresponding feature in comparison with adjacent pixels.

40. A non-transitory computer-readable storage medium storing instructions that, when executed, cause at least one processor to perform the method of claim 1.
